(19) United States
(12) Patent Application Publication
(10) Pub. No.: US 2012/0059677 A1
(43) Pub. Date: Mar. 8, 2012

(54) METHODS AND SYSTEMS FOR AUTOMATED, PREDICTIVE MODELING OF THE OUTCOME OF BENEFITS CLAIMS

(75) Inventor: Michael K. Crowe, Winchester, MA (US)

(73) Assignee: THE ADVOCATOR GROUP, LLC, Wakefield, MA (US)

(21) Appl. No.: 13/292,946

(22) Filed: Nov. 9, 2011

Related U.S. Application Data
(63) Continuation of application No. 12/394,161, filed on Feb. 27, 2009, now abandoned.
(60) Provisional application No. 61/032,491, filed on Feb. 29, 2008.

(51) Int. Cl. G06Q 40/08

(52) U.S. Cl. 705/4

(57) ABSTRACT

A system for automated, predictive modeling of the outcome of a benefits claim includes a profile generator, an evaluation component, and a case management application. The profile generator executes on a computing device and retrieves a claimant profile associated with an adjudicated claim. The evaluation component executes on the computing device and generates a prediction of an outcome of a claim brought by a potential claimant of a government benefit, responsive to the retrieved claimant profile. The evaluation component generates a recommendation to file the claim for the government benefit, responsive to the generated prediction. The case management application executes on the computing device, receives the generated prediction of the outcome of the claim and the generated recommendation and displays at least one of the generated prediction and the generated recommendation.

### CROSS-REFERENCE TO RELATED APPLICATIONS

The present application claims priority to U.S. Provisional Patent Application Ser. No. 61/032,491, entitled “Methods and Systems for Automated, Predictive Modeling of the Outcome of Benefits Claims” filed Feb. 29, 2008, which is incorporated herein by reference.

### FIELD OF THE INVENTION

This disclosure generally relates to methods and systems for modeling the outcome of benefits claims. In particular, this disclosure relates to methods and systems for automated, predictive modeling of the outcome of benefits claims.

### BACKGROUND OF THE INVENTION

Under certain circumstances, individuals who have been injured or are ill may make claims for certain government benefits, as well as making claims for benefits from private insurance sources. In some cases, an injured or ill individual may need to make a claim for a government benefit as an insurance policy requirement, or in addition to, or instead of, making claims under other policies, such as workers' compensation or insurance policy claims. In other instances, an employer needs to determine whether to recommend that an ill or injured employee make a claim for a government benefit. In still others, an insurance-providing entity, or compliance company, makes a recommendation on behalf of an employer. The government benefit may be an insurance claim, such as a Social Security Disability Insurance (SSDI) claim. In some situations, insurers in different coverage verticals, including, but not limited to, disability, workers' compensation, auto, and medical insurers, have the policy-based or statutory right to reduce or completely offset indemnity benefits when an insured becomes entitled to certain benefits, such as Social Security disability benefits (SSDB). Therefore, understanding whether and when to make a claim for a government benefit is typically important as the consequences of making the claim to the government benefit may negatively impact an individual's rights to other benefits.

### BRIEF SUMMARY OF THE INVENTION

The methods and systems described herein allow users to correlate data associated with prospective claims (such as information associated with an individual considering making a claim for a benefit) with data associated with previously-adjudicated claims (such as information associated with an individual who previously claimed a benefit, including information indicating whether the claim was granted or denied). In some embodiments, the methods and systems described herein allow users to optimize and improve financial performance to minimize claim payouts via offset, recovery, and reimbursement, stemming from a claimant's eligibility for a Social Security Disability Benefit (SSDB). In other embodiments, the methods and systems described herein allow users, such as long-term disability insurance providers, to consider how much they are paying monthly for a claim in order to help determine if they should refer the claim to another entity. In still other embodiments, the methods and systems described herein eliminate inefficiencies associated with in the manual processing and review of prospective claims. In further embodiments, instead of employing a protocol that relies on the subjective discretion of claim examiners or on arbitrary triggers (e.g., all claims with six months of long-term disability (LTD) duration should be referred for Social Security representation), users of the methods and systems described herein leverage uniform protocols and the results from predictive modeling, responsive to an analysis of data associated with individuals or groups seeking to claim benefits.

In one aspect, a system for automated, predictive modeling of the outcome of a benefits claim includes a profile generator, an evaluation component, and a case management application. The profile generator executes on a computing device and retrieves a claimant profile associated with an adjudicated claim. The evaluation component executes on the computing device and generates a prediction of an outcome of a claim brought by a potential claimant of a government benefit, responsive to the retrieved claimant profile. The evaluation component generates a recommendation to file the claim for the government benefit, responsive to the prediction. The case management application executes on the computing device, receives the generated prediction of the outcome of the claim and the generated recommendation and displays at least one of the generated prediction and the generated recommendation.

In another aspect, a method for automated, predictive modeling of the outcome of a benefits claim includes receiving, by a profile generator executing on a computing device, from a case management application, information associated with a potential claimant of a government benefit. The method includes retrieving, by the profile generator, a claimant profile associated with an adjudicated claim. The method includes generating, by an evaluation component executing on the computing device, a prediction of an outcome of a claim brought by the potential claimant for the government benefit, responsive to the retrieved claimant profile. The method includes generating, by an evaluation component executing on the computing device, a prediction of an outcome of a claim brought by the potential claimant for the government benefit, responsive to the retrieved claimant profile. The method includes generating, by the evaluation component, a recommendation to file the claim for the government benefit, responsive to the generated prediction. The method includes displaying, by the case management application, the recommendation.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client machines in communication with remote machines;

FIG. 1B is a block diagram depicting an embodiment of a computing device useful in connection with the methods and systems described herein;

FIGS. 2A and 2B are block diagrams depicting embodiments of a system for automated, predictive modeling of the outcome of benefits claims; and

FIGS. 3A and 3B are flow diagrams depicting embodiments of a method for automated, predictive modeling of the outcome of benefits claims.

### DETAILED DESCRIPTION

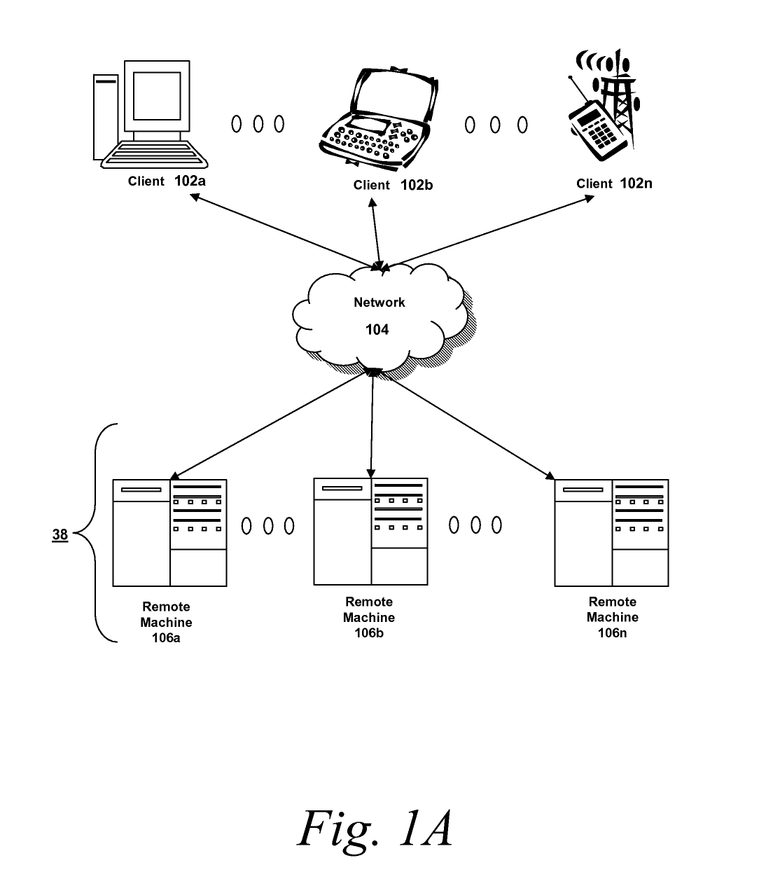

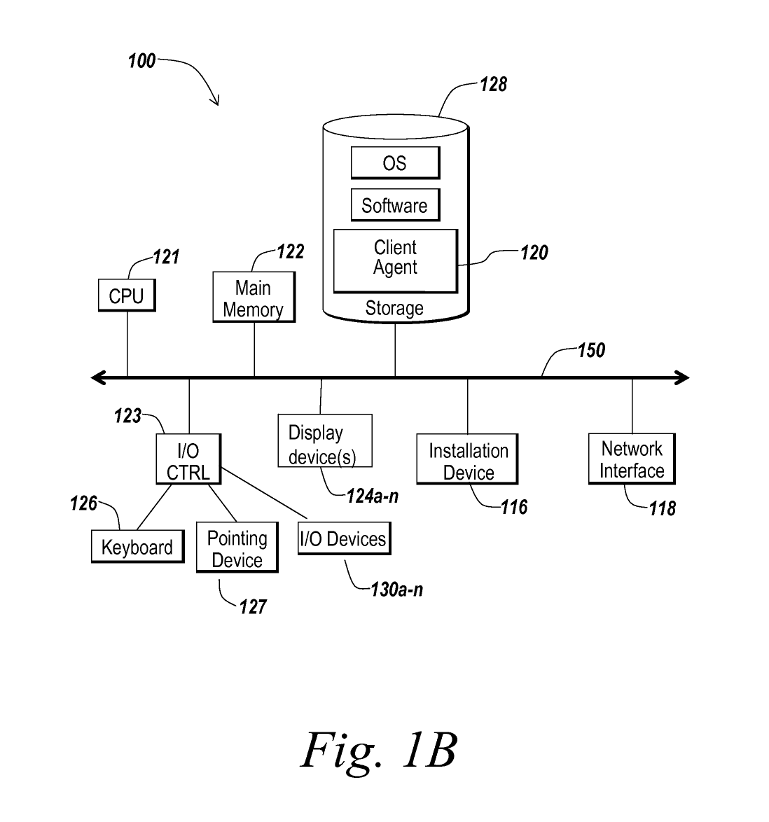

Referring now to FIG. 1A, an embodiment of a network environment is depicted. In brief overview, the network environment comprises one or more clients 102a-102n (also generally referred to as local machine(s) 102, or client(s) 102) in communication with one or more servers 106a-106n (also generally referred to as server(s) 106, or remote machine(s) 106) via one or more networks 104.

The servers 106 may be geographically dispersed from each other or from the clients 102 and communicate over a network 104. The network 104 can be a local-area network (LAN), such as a company Intranet, a metropolitan area network (MAN), or a wide area network (WAN), such as the Internet or the World Wide Web. The network 104 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network (including Wi-Fi, Wi-Fi hotspots, peer-to-peer ad-hoc wireless network (Bluetooth), VoWLAN, WVOIP) and a wireline network. In some embodiments, the network 104 may comprise a wireless link, such as an infrared channel or satellite band. The topology of the network 104 may be a bus, star, or ring network topology. The network 104 and network topology may be of any such network or network topology as known to those ordinarily skilled in the art capable of supporting the operations described herein. The network may comprise mobile telephone networks utilizing any protocol or protocols used to communicate among mobile devices, including AMPS, TDMA, CDMA, GSM, GPRS or UMTS. In some embodiments, different types of data may be transmitted via different protocols. In other embodiments, the same types of data may be transmitted via different protocols.

A server 106 may be referred to as a file server, application server, web server, proxy server, or gateway server. In one embodiment, the server 106 provides functionality of a web server. In some embodiments, the web server 106 comprises an open-source web server, such as the APACHE or TOMCAT servers maintained by the Apache Software Foundation of Delaware. In other embodiments, the web server executes proprietary software, such as the Internet Information Services products provided by Microsoft Corporation of Redmond, Wash., the SUN JAVA web server products provided by Sun Microsystems, of Santa Clara, Calif., the JBOSS products provided by Red Hat, Inc., of Raleigh, N.C., or the BEA WEBLOGIC products provided by BEA Systems, of Santa Clara, Calif.

The clients 102 may be referred to as client nodes, client machines, endpoint nodes, or endpoints. In some embodiments, a client 102 has the capacity to function as both a client node seeking access to resources provided by a server and as a server providing access to hosted resources for other clients 102a-102n. A client 102 may execute, operate or otherwise provide an application, which can be any type and/or form of software, program, or executable instructions such as any type and/or form of web browser, web-based client, client-server application, an ActiveX control, or a Java applet, or any other type and/or form of executable instructions capable of executing on client 102. The application can use any type of protocol and it can be, for example, an HTTP client, an FTP client, an Oscar client, a Virtual Private Network client, or a Telnet client.

The client 102 and server 106 may be deployed as and/or executed on any type and form of computing device, such as a computer, network device or appliance capable of communicating on any type and form of network and performing the operations described herein. FIG. 1B depicts a block diagram of a computing device 100 useful for practicing an embodiment of the client 102 or a server 106. As shown in FIG. 1B, each computing device 100 includes a central processing unit 121, and a main memory unit 122. As shown in FIG. 1B, a computing device 100 may include a visual display device 124, a keyboard 126 and/or a pointing device 127, such as a mouse.

The central processing unit 121 is any logic circuitry that responds to and processes instructions fetched from the main memory unit 122. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 100 may be based on any of these processors, or any other processor capable of operating as described herein.

The computing device 100 may include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56kb, X.25), broadband connections (e.g., ISDN, Frame Relay, ATM), wireless connections, or some combination of any or all of the above. The network interface 118 may comprise a built-in network adapter, network interface card, PCMCIA network card, card bus network adapter, wireless network adapter, USB network adapter, modem or any other device suitable for interfacing the computing device 100 to any type of network capable of communication and performing the operations described herein.

A wide variety of I/O devices 130a-130n may be present in the computing device 100. Input devices include keyboards, mice, trackpads, trackballs, microphones, and drawing tablets. Output devices include video displays, speakers, inkjet printers, laser printers, and dye-sublimation printers. The I/O devices may be controlled by an I/O controller 123 as shown in FIG. 1B. The I/O controller may control one or more I/O devices such as a keyboard 126 and a pointing device 127, e.g., a mouse or optical pen. Furthermore, an I/O device may also provide storage and/or an installation medium 116 for the computing device 100. In still other embodiments, the computing device 100 may provide USB connections to receive handheld USB storage devices such as the USB Flash Drive line of devices manufactured by Twintech Industry, Inc. of Los Alamitos, Calif.

In some embodiments, the computing device 100 may comprise or be connected to multiple display devices 124a-124n, which each may be of the same or different type and/or form. As such, any of the I/O devices 130a-130n and/or the I/O controller 123 may comprise any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may comprise multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices, such as computing devices 100a and 100b connected to the computing device 100, for example, via a network. These embodiments may include any type of software designed and constructed to use another computer's display device as a second display device 124a for the computing device 100. One ordinarily skilled in the art will recognize and appreciate the various ways and embodiments that a computing device 100 may be configured to have multiple display devices 124a-124n.

In further embodiments, an I/O device 130 may be a bridge between the system bus 150 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 100 of the sort depicted in FIG. 1B typically operates under the control of operating systems, which control scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, and WINDOWS VISTA, all of which are manufactured by Microsoft Corporation of Redmond, Wash.; MAC OS, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others. A server 106 and a client 102 may be heterogeneous, executing different operating systems.

In some embodiments, the computing device 100 may have different processors, operating systems, and input devices consistent with the device. For example, in one embodiment the computing device 100 is a TREO 180, 270, 1060, 600, 650, 680, 700p, 700w, or 750 smart phone manufactured by Palm, Inc. In some of these embodiments, the TREO smart phone is operated under the control of the PalmOS operating system and includes a stylus input device as well as a five-way navigator device.

In other embodiments the computing device 100 is a mobile device, such as a JAVA-enabled cellular telephone or personal digital assistant (PDA), such as the i55sr, i58sr, i85s, i88s, i90c, i95cl, or the iM1100, all of which are manufactured by Motorola Corp. of Schaumburg, Ill., the 6035 or the 7135, manufactured by Kyocera of Kyoto, Japan, or the i300 or i330, manufactured by Samsung Electronics Co., Ltd., of Seoul, Korea.

In still other embodiments, the computing device 100 is a Blackberry handheld or smart phone, such as the devices manufactured by Research In Motion Limited, including the Blackberry 7100 series, 8700 series, 7700 series, 7200 series, the Blackberry 7520, or the Blackberry PEARL 8100. In yet other embodiments, the computing device 100 is a smart phone, Pocket PC, Pocket PC Phone, or other handheld mobile device supporting Microsoft Windows Mobile Software. Moreover, the computing device 100 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

In some embodiments, the computing device 100 comprises a combination of devices, such as a mobile phone combined with a digital audio player or portable media player. In one of these embodiments, the computing device 100 is a Motorola RAZR or Motorola ROKR line of combination digital audio players and mobile phones. In another of these embodiments, the computing device 100 is an iPhone smartphone, manufactured by Apple Computer of Cupertino, Calif.

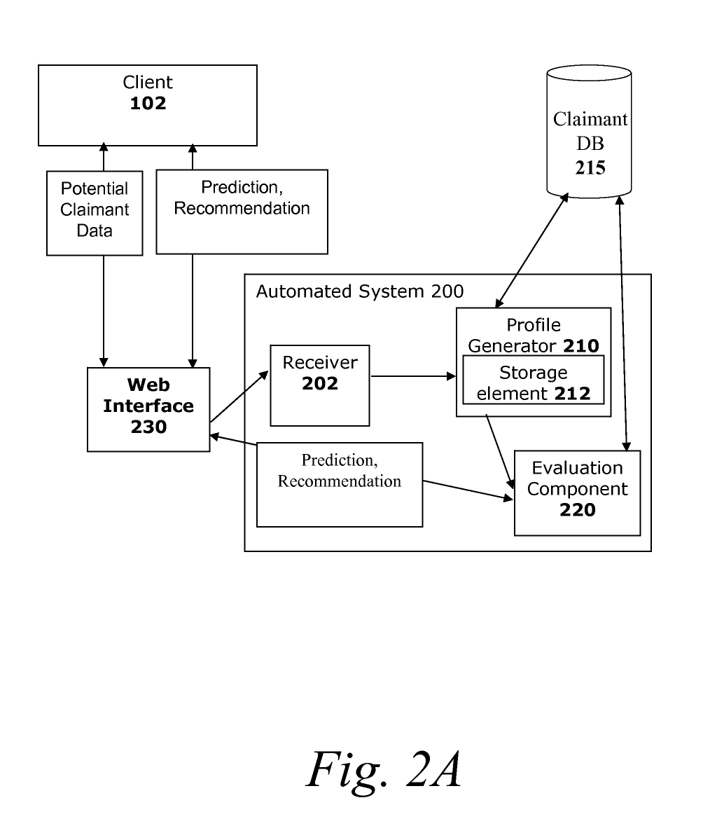

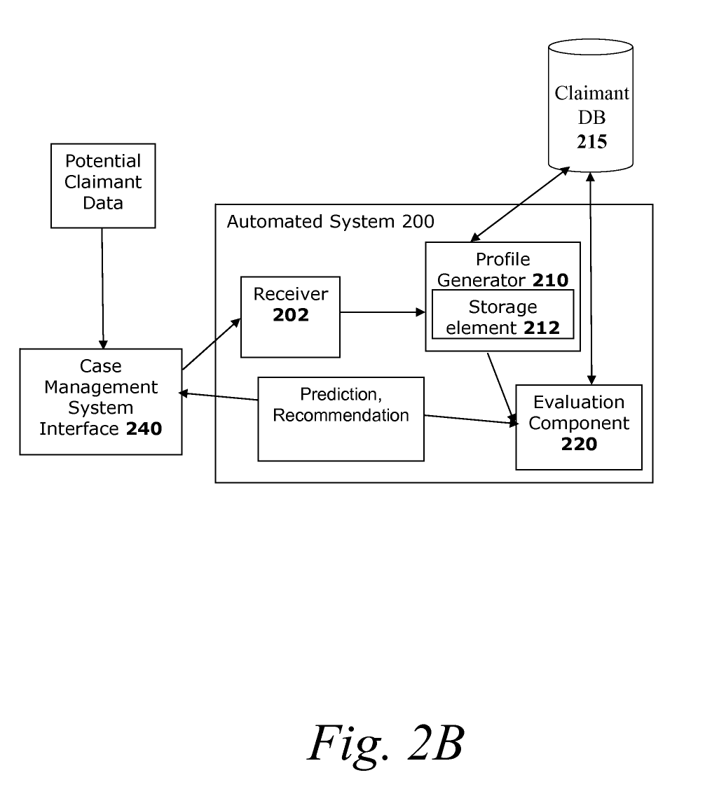

Referring now to FIG. 2A, a block diagram depicts one embodiment of a system for automated, predictive modeling of the outcome of benefits claims. In brief overview, the system includes an automated system 200, a receiver 202, a profile generator 210, a storage element 212, a claimant database 215, an evaluation component 220, and a web interface 230.

In some embodiments, an individual eligible for a benefit, such as Social Security Disability Insurance (SSDI), may be required to make a claim to the benefit before receiving additional benefits from other providers, such as long term disability providers, self-insured employers of the individual, or other insurance provider. For example, and in one of these embodiments, a previously-executed policy with an insurer may require the individual to make the claim before seeking a benefit from the insurer. In another of these embodiments, a provider, such as a secondary insurer, determines whether to require the individual to claim the benefit. In still another of these embodiments, a third-party affiliated with the provider makes the determination. In some embodiments, the claim is a private claim, a self-insured claim, or a web site referral. For example, and in other embodiments, an employer of an injured employee may subcontract a third party to determine whether to require the employee to seek SSDI benefits prior to the payment of long term disability benefits by the employer and, if so, to assist the employee in the process of making the claim for the benefit.

In one embodiment, an automated system 200 makes the determination of whether to recommend or to require an individual, such as an employee, to claim a benefit. In another embodiment, the automated system 200 determines whether to require the claiming of the benefit responsive to an analysis of the information associated with the individual. In still another embodiment, information associated with the individual includes, without limitation, the individual's personal data (such as name, residential information, social security number, or date of birth), an identification of a type of impairment suffered by the employee, a level of education of the employee, occupation, disability data (including date of disability or a medical code, such as a code in the International Statistical Classification of Diseases and Related Health Problems), and a history of benefits claimed previously, including an SSDI history. In still even another embodiment, information associated with the individual includes, without limitation, identifications of impairments, symptoms, physical and/or mental limitations, side effects of medications, medical history, methods of treatment, and past relevant work history. In yet another embodiment, the automated system 200 applies a predictive modeling algorithm to determine whether, and within what time frame, an insured will become entitled to SSDB and Medicare benefits.

In one embodiment, the system includes a profile generator 210, a claimant database 215, and an evaluation component 220. In another embodiment, the profile generator 210 executes on a computing device 100 and retrieves a claimant profile associated with an adjudicated claim. In still another embodiment, the profile generator 210 receives information associated with an individual and generates a claimant profile for the individual. In still even another embodiment, an evaluation component executing on the computing device generates a prediction of an outcome of a claim brought by a potential claimant of a government benefit, responsive to the retrieved claimant profile and generates a recommendation to file the claim for the government benefit, responsive to the generated prediction. In yet another embodiment, a case management application executing on the computing device receives the generated prediction of the outcome of the claim and the generated recommendation and displays at least one of the generated recommendation and the generated prediction.

In one embodiment, the profile generator 210 stores the claimant profile in the claimant database 215. In another embodiment, the profile generator 210 stores the claimant profile associated with the individual presently under evaluation separately from claimant profiles associated with previously evaluated individuals. In still another embodiment, the profile generator 210 includes a storage element 212 for storing generated data sets and claimant profiles.

In one embodiment, the profile generator 210 includes a graphical user interface to receive information associated with the individual. In another embodiment, the profile generator 210 displays, via the graphical user interface, a questionnaire to a user to collect information associated with the individual. In still another embodiment, the profile generator 210 includes a receiver 202 receiving one or more individual profiles from a user. In still even another embodiment, the receiver 202 receives, from a case management application, information associated with a potential claimant. In yet another embodiment, the profile generator 210 includes a transmitter that sends the information associated with the individual, or a generated data set associated with the individual, to the evaluation component 220 for analysis.

In some embodiments, the profile generator 210 receives information associated with an individual, generates a data set comprising a claimant profile for the individual, and stores the generated data set. In one of these embodiments, the claimant profile includes, but is not limited to, claimant age, jurisdiction, primary and secondary medical diagnosis, education level, employment skill level, claim duration, level of award, medical history, as well as personal information such as residential addresses, contact information, addictions, and hobbies, and other co-morbid factors. In another of these embodiments, the claimant profile includes, without limitation, information associated with an award received by an individual who made a benefits claim, the information including claimant past due benefits, attorney fees, and claimant payment history. In still another of these embodiments, the claimant profile includes, without limitation, information such as data from third party sources, including Social Security Administration publications, long-term disability statistics, medical coding, and labor statistics.

In one embodiment, the claimant database 215 stores information associated with individuals who have previously claimed benefits. In another embodiment, the claimant database 215 stores claimant profiles summarizing information associated with at least one claimant. In still another embodiment, the claimant database 215 stores an association between an outcome of an individual's claim to a benefit and information associated with the individual.

In one embodiment, a user accesses an evaluation component 220 to determine whether to require an individual to claim a benefit. In another embodiment, the evaluation component 220 receives information associated with the individual. In still another embodiment, the evaluation component 220 receives a claimant profile of the individual. In still even another embodiment, the evaluation component 220 applies an algorithm to received information associated with the individual to predict an outcome of a claim by the individual for a benefit.

In one embodiment, the evaluation component 220 compares the received information to at least one stored claimant profile. In another embodiment, the evaluation component 220 receives information associated with the individual from the profile generator 210 and compares the received information to information retrieved from the claimant database 215. For example, and in still another embodiment, the evaluation component 220 may determine whether an individual potentially claiming a benefit will succeed in claiming the benefit by comparing an identification of an impairment and of an age of the individual with an identification of an impairment and an age included in a claimant profile associated with a second individual who previously claimed a benefit. In some embodiments, the evaluation component 220 generates a prediction of a length of time needed to adjudicate a claim; for example, the evaluation component 220 may include an analysis component that analyzes the received information to generate the prediction. In other embodiments, the evaluation component 220 generates a recommendation to defer filing of the claim for the government benefit, responsive to the generated prediction. In still other embodiments, the evaluation component 220 generates a recommendation not to file the claim for the government benefit, responsive to the generated prediction.

In some embodiments, the automated system 200 is an internet-based system. In one of these embodiments, a user accesses a web interface of a case management application to provide information associated with a potential claimant to the automated system 200. In another of these embodiments, the evaluation component 220 generates a recommendation regarding whether the individual should make a claim for a benefit, responsive to receiving the information from the user via the web interface 230. In still another of these embodiments, the automated system 200 displays the generated recommendation to the user via the web interface 230. In yet another of these embodiments, the automated system 200 is provided in a web-enabled application service provider (ASP) format. In others of these embodiments, the automated system 200 communicates with a client system 102 as described above in connection with FIG. 1A and 1B. In some embodiments, a user exchanges information with the automated system 200 via an encrypted, password-protected session. In other embodiments, the user exchanges information with the automated system 200 via a Secure Sockets Layer network connection. In still other embodiments, the user exchanges information with the automated system 200 via an encrypted FTP session.

In some embodiments, the automated system 200 allows a user to filter single or aggregate claims data runs. In one of these embodiments, the automated system 200 provides a graphical user interface to the profile generator 210 for the evaluation of a single claim. In another of these embodiments, the automated system 200 allows a user to upload a plurality of claims for evaluation. In still another of these embodiments, the automated system 200 specifies a data format for use in uploading claims for evaluation by the evaluation component 220. In yet another of these embodiments, the automated system 200 provides access to an encrypted FTP session for use in uploading claims for evaluation.

Referring now to FIG. 2B, a block diagram depicts one embodiment of a system in which an automated system 200 is integrated with a case management software application for the automated prediction and modeling of the outcome of benefits claims. In brief overview, the system includes an automated system 200, a receiver 202, a profile generator 210, a storage element 212, a claimant database 215, an evaluation component 220, and a case management system interface 240. In some embodiments, the case management system interface 240 includes an internet-based connection to the automated system 200. In other embodiments, the case management system and the automated system 200 are portions of a single, integrated software application. In still other embodiments, the case management system and the automated system 200 are portions of a distributed software application.

In one embodiment, the profile generator 210 accesses information received from a user via an interface provided by the case management software application. In another embodiment, the profile generator 210 receives information stored in a claimant database 215 maintained by the case management software application. In still another embodiment, the evaluation component 220 receives claimant information directly from a user via an interface provided by the case management software application.

In some embodiments, the case management software application may include customized software based upon a business process management platform. In one of these embodiments, the case management software application includes a proprietary software application. In other embodiments, the case management software application may include commercial, off-the-shelf products. In still other embodiments, the integrated software will rate disability and other insurance claims as to SSDB and Medicare viability, duration from application to adjudication, and estimated monthly SSDB payment, with flexibility and customized development for the particular case management software with which the automated system 200 is integrated.

In other embodiments, the methods and systems described herein allow users to model an outcome for medical case management and the identification and pursuit of third party claims to which the insurer has a policy and equitable right of subrogation, lien, or reimbursement. In still other embodiments, the methods and systems described herein are provided to users on a subscription basis.

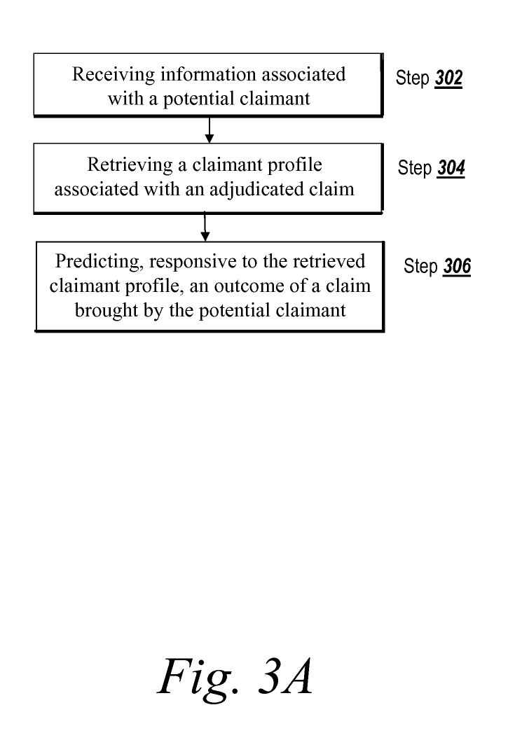

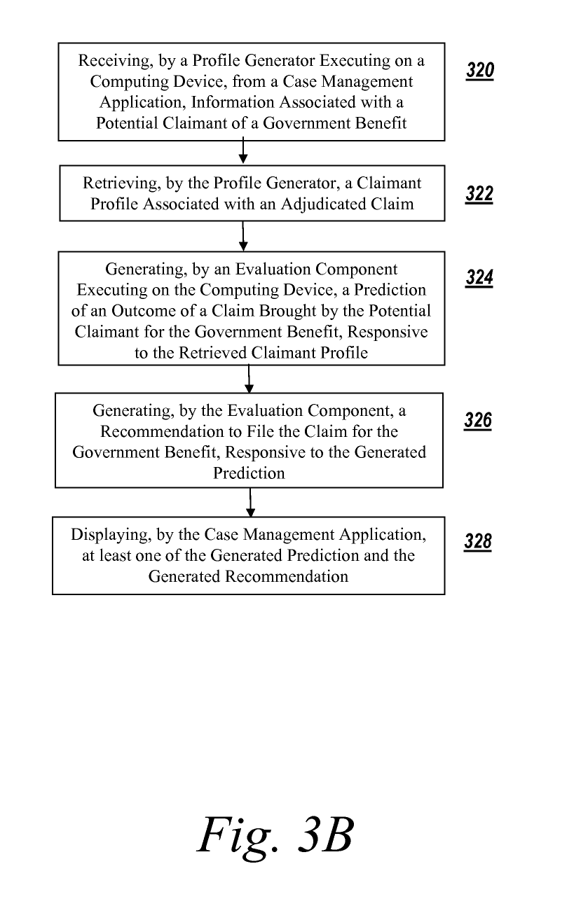

Referring now to FIG. 3A, a flow diagram depicts an embodiment of the steps taken in a method for automated, predictive modeling of the outcome of a benefits claim. In one embodiment, this method replaces a manual, subjective process. In another embodiment, this method is used in conjunction with a manual, subjective process. In brief overview, the method includes receiving information associated with a potential claimant (302). The method includes the step of retrieving a claimant profile associated with an adjudicated claim 304). The method includes the step of predicting, responsive to the retrieve claimant profile, an outcome of a claim brought by the potential claimant (306).

Information associated with a potential claimant is received (302). In one embodiment, the receiver 202 receives the information. In another embodiment, the web interface 230 receives the information. In still another embodiment, the web interface 230 forwards the received information to the receiver 202. In still even another embodiment, the receiver 202 is a web interface 230. In yet another embodiment, the web interface 230 forwards the received information to the profile generator 210. In some embodiments, the profile generator 210 receives the information. In one of these embodiments, the profile generator 210 receives the information from the receiver 202. In another of these embodiments, the profile generator 210 receives the information from the web interface 230.

A claimant profile associated with an adjudicated claim is retrieved (304). In one embodiment, the evaluation component 220 retrieves the claimant profile. In another embodiment, the evaluation component 220 retrieves the claimant profile from the claimant database 215.

An outcome of a claim brought by the potential claimant is predicted, responsive to the retrieve claimant profile (306). In one embodiment, the method provides an objective, automated process for modeling the outcome of a claim for benefits. In some embodiments, the evaluation component 220 scores a claim. In other embodiments, the evaluation component 220 predicts an outcome of a claim responsive to a score associated with the claim. In still other embodiments, the evaluation component 220 compares a claim to an adjudicated claim. In yet other embodiments, the evaluation component 220 compares a claim to a pending claim. In one of these embodiments, for example, the evaluation component 220 compares a claim to a pending claim when predicting a timeline for the claim. For example, the evaluation component may predict a length of time required to adjudicate the claim by comparing the claim to similar, still-pending claims.

Referring now to FIG. 3B, a flow diagram depicts an embodiment of the steps taken in a method for automated, predictive modeling of the outcome of a benefits claim. In brief overview, the method includes receiving, by a profile generator executing on a computing device, from a case management application, information associated with a potential claimant of a government benefit (320). The method includes retrieving, by the profile generator, a claimant profile associated with an adjudicated claim 322). The method includes generating, by an evaluation component executing on the computing device, a prediction of an outcome of a claim brought by the potential claimant for the government benefit, responsive to the retrieved claimant profile (324). The method includes generating, by the evaluation component, a recommendation to file the claim for the government benefit, responsive to the generated prediction (326). The method includes displaying, by the case management application, at least one of the generated prediction and the generated recommendation (328). FIG. 3B depicts, in greater detail, some embodiments of the method described in connection with FIG. 3A.

Referring now to FIG. 3B, and in greater detail, the method includes receiving, by a profile generator executing on a computing device, from a case management application, information associated with a potential claimant of a government benefit (320). In one of these embodiments, the profile generator receives the information as described above in connection with FIG. 3A.

In some embodiments, the profile generator 210 applies a data mining technique to extract a data point from information associated with an individual. In one of these embodiments, retrieved data points include type of disability, claimant age, claimant age at time of disability, claimant gender, date of birth, jurisdiction, co-morbid factors, medical history, methods of medical treatment, primary and secondary medical diagnoses, date of disability (loss), education level, occupation, employment skill level, salary, claim duration, level of award sought, co-morbid factors, location of nearest Social Security office, length of time since the disability was diagnosed, length of time since the disabling event occurred, and other factors associated with the individual. In another of these embodiments, an employment skill level is based on a Physical Demand Strength Rating as classified in the U.S. Department of Labor's Dictionary of Occupational Titles, which includes: sedentary work, light work, medium work, heavy work, very heavy work, and unknown level of work. In still another of these embodiments, a data point includes a length of service, such as the time from the date of hire to date of disability. In still even another of these embodiments, a data point includes an indication as to whether the individual has a mental disability. In still another of these embodiments, a data point identifies a metropolitan statistical area or identification of primary metropolitan statistical area of claimant's residence. Since Federal MSA/PMSA designations incorporate economic and commutation patterns along with population, such a data point may provide relevant data for determinations about availability of employment opportunities.

In one embodiment, entered data is displayed in a summarized format to a user, with a score; for example, a user may receive a display of mined data points—such as the following: Age=35, Disability=Lung Cancer, Occupation=Long Haul Truck Driver—with scores such as: 35=2, Lung Cancer=10, Truck Driver=6. In another embodiment, the data mining technique used is one of a Classification And Regression Trees (CART) technique, a Classification And Regression Trees (CHAID) technique, a C4.5 algorithm-based technique, or other decision tree techniques used for classification of a dataset. In still another embodiment, the applicability of each data field in a claimant profile is scored; for example, some fields may be given more or less weight than others in scoring a claimant.

In one embodiment, the profile generator 210 stores the received information. In another embodiment, the profile generator 210 stores data associated with the received information. In still another embodiment, the profile generator 210 generates a claimant profile for the potential claimant, responsive to receiving the information. In yet another embodiment, the profile generator 210 stores the claimant profile; for example, the profile generator 210 may store the claimant profile in the claimant database 215 or in the storage element 212.

A claimant profile associated with an adjudicated claim is retrieved (322). In one embodiment, the evaluation component 220 retrieves the claimant profile. In another embodiment, the evaluation component 220 retrieves the claimant profile from the claimant database 215. In still another embodiment, the profile generator retrieves the claimant profile. In yet another embodiment, the profile generator retrieves a claimant profile associated with a pending claim. In some embodiments, a claimant profile associated with a pending claim is retrieved instead of, or in addition to, a claimant profile associated with an adjudicated claim. In other embodiments, the profile generator generates a claimant profile for a potential claimant. In one of these embodiments, the profile generate retrieves a claimant profile from a claimant database 215 that has at least one data point in common with the generated claimant profile.

In some embodiments, a retrieved claimant profile indicates that a benefit in an adjudicated claim was awarded. In other embodiments, a retrieved claimant profile indicates that a benefit in an adjudicated claim was denied. In still other embodiments, a retrieved claimant profile indicates that a benefit in an adjudicated claim was awarded as of an alleged onset date. In further embodiments, a claim is adjudicated if an award date has been specified.

In some embodiments, the retrieved claimant profile includes at least one data point substantially similar to a data point extracted from information associated with an individual. In one of these embodiments, retrieved data points in the retrieved claimant profile include those described above in connection with FIG. 3A (320). In other embodiments, data points in the retrieved claimant profile include, without limitation, a length of time between a date on which the claimant made an initial claim and a date on which the claimant received an initial decision on his or her claim, a length of time between a date on which the claimant last worked and a date on which the claimant received an initial decision on his or her claim, and an identification of a type of decision made on the initial claim, such as an award, award amount, denial, or default decision (for example, if no decision type is listed and a certain amount of time has passed or a type of an event, such as a hearing, has occurred, a default decision, such as a denial, may be assigned to the claimant profile).

An evaluation component executing on the computing device generates a prediction of an outcome of a claim brought by the potential claimant for the government benefit, responsive to the retrieved claimant profile (324). In some embodiments, the evaluation component 220 predicts whether an individual will be successful in claiming a benefit by comparing a first plurality of data points identified from the individual's claimant profile with a second plurality of data points associated with stored claimant profiles retrieved from the claimant database 215. In other embodiments, the evaluation component 220 identifies a likely time frame within which an individual will become entitled to a benefit by comparing data points identified from the individual's claimant profile with a plurality of data points associated with stored claimant profiles retrieved from the claimant database 215. In still other embodiments, the evaluation component 220 identifies a level of benefit for which an individual is likely to be eligible by comparing data points identified from the individual's claimant profile with a plurality of data points associated with stored claimant profiles retrieved from the claimant database 215. In still even other embodiments, the evaluation component 220 predicts an amount of the benefits payout for which the individual will be eligible by comparing data points identified from the individual's claimant profile with a plurality of data points associated with stored claimant profiles retrieved from the claimant database 215. In yet other embodiments, the evaluation component 220 generates a prediction of a length of time needed to adjudicate a claim. In one of these embodiments, the evaluation component 220 predicts a length of time required for adjudication and payment of a benefit from a time of an initial claim to the benefit by comparing data points identified from the individual's claimant profile with a plurality of data points associated with stored claimant profiles retrieved from the claimant database 215. In further embodiments, the evaluation component 220 predicts a cost associated with handling a claim.

In one embodiment, the evaluation component 220 compares at least one data point associated with a potential claimant with at least one data point associated with an existing claimant. In another embodiment, the evaluation component 220 compares at least one data point associated with a first individual claiming a benefit with at least one data point associated with a second individual who previously sought a claim benefit, which may include individuals whose claims are still pending as well as individuals whose claims have been adjudicated. In another embodiment, the evaluation component 220 applies an algorithm to predict whether an individual claiming a benefit will receive the benefit, for how long the individual will be eligible for the benefit, and what level of benefit will be awarded, if any. In another embodiment, the evaluation component 220 applies an algorithm to predict a level of benefit for which a potential claimant of a benefit will be eligible.

In some embodiments, the evaluation component 220 evaluates the duration of a claim, the age of an individual, claimant jurisdiction, a level of education of an individual, past relevant work of an individual, primary and secondary diagnoses, classification of the claim (including, for example, whether the claim is related to a mental or nervous or psychiatric disability), and co-morbid factors, to predict the outcome of a claim for benefits. In one of these embodiments, the evaluation component 220 determines whether an individual will be determined to be disabled based upon an application of a rule to information associated with the individual. In another of these embodiments, the evaluation component 220 as part of an automated, predictive system, assigns a score to information associated with the individual. For example, and in still another of these embodiments, an automated system 200 assigns a score to at least one of a disability duration to date (e.g., the individual has been disabled for six months), an age of the individual, an education level of the individual, and past work skills (unskilled, skilled, or semiskilled). In some embodiments, the evaluation component generates a recommendation regarding whether to file a claim for a government benefit, based upon a generated prediction.

The evaluation component generates a recommendation to file the claim for the government benefit, responsive to the generated prediction (326). In some embodiments, the evaluation component 220 generates a recommendation to defer the filing of the claim for the government benefit until a later date, responsive to the generated prediction. In other embodiments, the evaluation component 220 generates a recommendation not to file the claim for the government benefit, responsive to the generated prediction.

In some embodiments, the evaluation component 220, or other component in the automated system 200, applies a rule to the assigned score to determine whether to recommend that the individual claim a benefit and what time frame is predicted for the adjudication of the claim. For example, and in one of these embodiments, the automated system 200 may assign a score of 15 to an individual who has been disabled for six months, is over 55 years of age, has less than an 11^{th} grade education and is semiskilled and the automated system 200 may apply a rule indicating that a score of 15 should result in a recommendation that an individual make a claim for a benefit. In an alternative embodiment, the automated system 200 may apply a rule indicating that a score of 15 should result in a deferral of a claim for a benefit and a re-evaluation of the individual after a predetermined period of time. In some embodiments, the automated system 200 provides a rationale behind a recommendation for deferring a claim, filing a claim, or not filing a claim.

In some embodiments, the factors evaluated by the automated system 200 are the factors that are used to determine whether an individual will qualify for a benefit, such as a SSDB. In other embodiments, the factors evaluated by the automated system 200 include a correlation between information associated with a potential claimant and information associated with a previously-adjudicated claim. For example, in one of these embodiments, the automated system 200 applies a rule to determine whether to recommend that an individual make a claim to a benefit when the individual's claimant profile matches a claimant profile for an individual who previously sought a benefit and who had a similar impairment or level of skill as the potential claimant.

In some embodiments, the evaluation component 220 provides enhanced protocols in determining whether to recommend that an individual claim a benefit. In one of these embodiments, a protocol relates to the scoring of a claim, for example by indicating that a score assigned to a factor under evaluation depends on other factors. For example, and in another of these embodiments, a low score for a first factor may be associated with a particular recommendation; however, a rule may indicate that the recommendation is to be revised should a second factor received a high score. In another example, if one value is low (ex. Age=35), another needs to be higher than normal (ex. Job Skill=Unskilled) because in this embodiment, each data set will have values and in order for a referral to be made a low score in one value needs to be offset by a high one elsewhere. In still another of these embodiments, the use of the enhanced protocols will not only optimize available SSDB offsets, but will also reduce risk and liability associated with litigation resulting when customers refer claimants for SSDB application, as required by contract, and then terminate the claim at some point in the process because the claimant may no longer meet the insurance policy definition of “disabled”.

In one embodiment, the evaluation component 220 generates a score responsive to the entered data and automatically displays it to a user. In another embodiment, the score is an indication of whether or not the claim should be referred and a prediction of whether the claim will be awarded at any point. In some embodiments, the evaluation component 220 generates a prediction by comparing the received data with similar claimant profiles stored in the database to provide additional data. In one of these embodiments, the evaluation component 220 generates a score as well as a prediction. In another of these embodiments, the evaluation component 220 indicates that of all nearly exact profiles currently stored in the database, X% were approved in Y days and, therefore, the likelihood of this given claim being approved is Z—because the greater the similarity between profiles the greater the chances of a similar outcome in a similar time-frame. In still another embodiment, the evaluation component 220 receives from a user an indication of a factor—such as an amount of time allotted for adjudication—and the evaluation component 220 determine the likelihood of this claim being approved based upon the factor—for example by determining the likelihood of the claim being approved in X days.

In one embodiment, a claimant profile is modified to store a recommendation identified by the automated system 200. In another embodiment, the modified claimant profile is stored in the claimant database 215. In some embodiments, the method includes the step of receiving an identification of a result of a claim for a benefit. In one of these embodiments, the method includes the step of receiving a correction to a prediction; for example, if the automated system 200 predicted the award of a claim based on criteria (such as information in the claimant profile) and the award was different or not awarded, an identification of the disparity may be stored in the claimant profile. In another of these embodiments, an evaluation component 220 modifies data used to make a prediction of the result of a claim—such as a predictive modeling algorithm—based upon a received correction to a prediction. In still another of these embodiments, the accuracy of the evaluation component 220 improves upon incorporating the correction into the claimant profiles for use in subsequent evaluations. In still even another of these embodiments, the received correction is manually incorporated into the claimant profile. In yet another embodiment, the received correction is automatically incorporated into the claimant profile.

In one embodiment, the evaluation component and the case management application execute on the same computing device. For example, the case management system interface 240 shown in FIG. 2B may be provided as part of the automated system 200, for example as part of the receiver 202 and the displayed web interface 230. In another embodiment, the evaluation component and the case management component execute on different systems. For example, the case management system interface 240 shown in FIG. 2B may execute on a first machine 106a in a network 104 while the automated system and the evaluation component 220 execute on a second machine 106b.

The case management application, such as the automated system 200, displays at least one of the generated prediction and the generated recommendation. In some embodiments, a recommendation based upon a prediction generated by the evaluation component 220 is transmitted to a user. In one of these embodiments, a web interface 230 displays the prediction to the user via a graphical user interface. In another of these embodiments, a case management system interface 240 receives the prediction and transmits the prediction to the user. In still another of these embodiments, the user makes the recommendation. In yet another of these embodiments, the user modifies or overrides the recommendation.

In one embodiment, in the disability insurance industry, disability claim payers also seek to exhaust vocational rehabilitations (return to work) and medical management efforts to reduce claim cost before they send a “dual message” by requiring the claimant file the SSDB application. The Social Security standard of disability is presently, in essence, a total disability standard under federal law. The use of predictive modeling as described herein will allow for the use of constrained claim handling protocols that balance these competing interests.

The systems and methods described above may be provided as one or more computer-readable programs embodied on or in one or more articles of manufacture. The article of manufacture may be a floppy disk, a hard disk, a CD-ROM, a flash memory card, a PROM, a RAM, a ROM, or a magnetic tape. In general, the computer-readable programs may be implemented in any programming language, such as LISP, PERL, C, C++, C#, PROLOG, Visual Basic, or any byte code language such as JAVA. The software programs may be stored on or in one or more articles of manufacture as object code.

Having described certain embodiments of methods and systems for automated, predictive modeling of the outcome of benefits claims, it will now become apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for automated, predictive modeling of the outcome of a benefits claim, the method comprising:
receiving, by a profile generator executing on a computing device, from a case management application, information associated with a potential claimant of a government benefit;
retrieving, by the profile generator, a claimant profile associated with an adjudicated claim;
generating, by an evaluation component executing on the computing device, a prediction of an outcome of a claim brought by the potential claimant for the government benefit, responsive to the retrieved claimant profile;
generating, by the evaluation component, a recommendation to file the claim for the government benefit, responsive to the generated prediction; and
displaying, by the case management application, at least one of the generated prediction and the generated recommendation.

2. The method of claim 1 further comprising retrieving, by the profile generator, a claimant profile associated with a pending claim.

3. The method of claim 1 further comprising generating, by the profile generator, a claimant profile for the potential claimant, responsive to the received information.

4. The method of claim 1 further comprising comparing, by the evaluation component, at least one data point associated with the potential claimant with at least one data point associated with an existing claimant.

5. The method of claim 1 further comprising applying, by the evaluation component, an algorithm to information associated with the potential claimant to predict a level of benefit for which the potential claimant will be eligible.

6. The method of claim 1, wherein generating, by an evaluation component, a prediction of an outcome of a claim further comprises generating, by the evaluation component, a prediction of a length of time needed to adjudicate the claim.

7. The method of claim 1, wherein generating, by the evaluation component, the recommendation to file the claim comprises generating, by the evaluation component, a recommendation to defer filing of the claim for the government benefit, responsive to the generated prediction.

8. The method of claim 1, wherein generating, by the evaluation component, the recommendation to file the claim comprises generating, by the evaluation component, a recommendation not to file the claim for the government benefit, responsive to the generated prediction.

9. A system for automated, predictive modeling of the outcome of a benefits claim comprising:
a profile generator executing on a computing device and retrieving a claimant profile associated with an adjudicated claim;
an evaluation component executing on the computing device, generating a prediction of an outcome of a claim brought by a potential claimant of a government benefit, responsive to the retrieved claimant profile, and generating a recommendation to file the claim for the government benefit, responsive to the generated prediction; and
a case management application executing on the computing device, receiving the generated prediction of the outcome of the claim and the generated recommendation and displaying at least one of the generated recommendation and the generated prediction.

10. The system of claim 9, wherein the profile generator further comprises means for receiving, from the case management application, information associated with the potential claimant.

11. The system of claim 9, wherein the profile generator further comprises means for generating a claimant profile associated with the potential claimant.

12. The system of claim 9, wherein the evaluation component further comprises means for generating a prediction of a length of time needed to adjudicate the claim.

13. The system of claim 9, wherein the evaluation component further comprises means for generating a recommendation to defer filing of the claim for the government benefit, responsive to the generated prediction.

14. The system of claim 9, wherein the evaluation component further comprises means for generating a recommendation not to file the claim for the government benefit, responsive to the generated prediction.

15. The system of claim 9 further comprising a second computing device executing the case management application.

16. The system of claim 9 further comprising a case management user interface, provided by the case management application, displayed to a user of the case management application and receiving information associated with the potential claimant.

17. A computer readable medium having instructions thereon that when executed provide a method for automated, predictive modeling of the outcome of a benefits claim, the computer readable media comprising:
instructions to receive, by a profile generator executing on a computing device, from a case management application, information associated with a potential claimant of a government benefit;
instructions to retrieve, by the profile generator, a claimant profile associated with an adjudicated claim;
instructions to generate, by an evaluation component executing on the computing device, a prediction of an outcome of a claim brought by the potential claimant for the government benefit, responsive to the retrieved claimant profile;
instructions to generate, by the evaluation component, a recommendation to file the claim for the government benefit, responsive to the generated prediction; and
instructions to display, by the case management application, the recommendation.

18. The computer readable medium of claim 17 further comprising instructions to retrieve, by the profile generator, a claimant profile associated with a pending claim.

19. The computer readable medium of claim 17 further comprising instructions to generate, by the profile generator, a claimant profile for the potential claimant, responsive to the received information.

20. The computer readable medium of claim 17 further comprising instructions to compare, by the evaluation component, at least one data point associated with a potential claimant with at least one data point associated with an existing claimant.

21. The computer readable medium of claim 17 further comprising instructions to apply, by the evaluation component, an algorithm to information associated with the potential claimant to predict a level of benefit for which the potential claimant will be eligible.

22. The computer readable medium of claim 17 further comprising instructions to generate, by the evaluation component, a prediction of a length of time needed to adjudicate the claim.

23. The computer readable medium of claim 17 further comprising instructions to generate, by the evaluation component, a recommendation to defer filing of the claim for the government benefit, responsive to the generated prediction.

24. The computer readable medium of claim 17 further comprising instructions to generate, by the evaluation component, a recommendation not to file the claim for the government benefit, responsive to the generated prediction.
